(19) United States
(12) Patent Application Publication
(10) Pub. No.: US 2017/0166794 A1
(43) Pub. Date: Jun. 15, 2017

(54) FILTER CONTROL HPHT ADDITIVE FOR OIL-BASED DRILLING FLUIDS WITH PETROLEUM COKE

(71) Applicant: Intevep, S.A., Caracas (VE)

(72) Inventor: Miguel Angel Pérez Cisneros, Edo. Miranda (VE)

(73) Assignee: Intevep, S.A., Caracas (VE)

(21) Appl. No.: 14/966,251

(22) Filed: Dec. 11, 2015

(51) Int. Cl. C09K 8/035; C09K 8/03; C09K 8/32; E21B 21/00

(52) U.S. Cl. CPC C09K 8/035; E21B 21/003; C09K 8/032; C09K 8/32

(57) ABSTRACT

A method for controlling filtration loss during drilling to a downhole hydrocarbon bearing formation by drilling with a drilling fluid containing a filtration control additive that is made up of petroleum coke particles impregnated with a cationic surfactant and coated with a butadiene-styrene polymer.

### BACKGROUND OF THE INVENTION

This invention relates to a method of filtration control during drilling of a well to a downhole hydrocarbon bearing formation.

Resources such as gas, oil, and water residing in a subterranean formation are usually recovered by drilling a well to the subterranean formation while using drilling fluids. These drilling fluids lubricate the drill bit, bring cuttings to the surface, and balance pressure of formations being drilled through. One important property of drilling fluids is the ability to control or resist filtration, which is the loss of fluids from the well through the wall of the well bore and into the surrounding formation. In order to resist filtration, the drilling fluid can be formulated to deposit a filter cake on the wellbore wall wherein the cake has a permeability to wellbore fluids which is as low as possible in order to maintain a stable borehole and reduce filtrate volume invasion of well fluids into the formation.

Various methods exist for creating the cake including using organophilic lignite additives in the drilling fluid. Drawbacks to using such additives include a lack of local availability and high cost. The need exists for an additive to a drilling fluid which possesses the desired properties and is affordable and available in good supply.

### SUMMARY OF THE INVENTION

According to the invention, a composition and method are provided to improve the filtration control of a downhole drilling operation that uses drilling fluids.

The present invention features a method for controlling filtration losses during drilling to a downhole hydrocarbon bearing formation using a drilling fluid containing a filtration control additive that forms a filter cake. The additive can be made of a particulate petroleum coke product, a butadiene-styrene polymer, a cationic surfactant, which is preferably based on a fatty acid with a typical alkyl distribution of (C₁₂ 1%, C₁₄ 14%, C₁₆ 31% and C₁₈ 64%), isopropyl alcohol, and cyclohexane. These components are used, according to the invention, to produce a composite particle of petroleum coke which is impregnated with the cationic surfactant and coated with the butadiene-styrene polymer. It has been found that while these particles in a filtration loss additive work by potentially different mechanisms from other additives, they are equally as effective, and provide for the additive using ingredients which are more readily available and at a lower cost.

A method for controlling filtration losses during drilling to a downhole hydrocarbon bearing formation according to the invention includes the steps of drilling a well bore with a drilling fluid containing a filtration control additive so as to form a filter cake on walls of the well bore, wherein the filtration control additive comprises petroleum coke particles having a particle size between 190 and 200 mesh, the particles being impregnated with a cationic surfactant and coated with a butadiene-styrene polymer.

A method for making a filtration control additive according to the invention includes the steps of: (a) mixing a cationic surfactant with petroleum coke particles so as to absorb and impregnate the particles with the surfactant to produce surfactant-impregnated particles, (b) forming a mixture of the surfactant-impregnated particles and a butadiene-styrene polymer dispersion in cyclohexane, and (c) mixing the mixture so as to coat the surfactant-impregnated particles with butadiene-styrene polymer. The mixing in step (c) can be carried out at a mixing intensity of about 90 rpm for about 6 hours. Addition of the SBR polymer can preferably be done using an organic dispersion in cyclohexane and having a concentration of SBR of about 7% by volume.

The drilling fluid additive according to the invention comprises petroleum coke particles having a particle size between 190 and 200 mesh, the particles being impregnated with a cationic surfactant and coated with a butadiene-styrene polymer. These particles are referred to herein as being composite particles due to the presence of the surfactant and SBR. Further, according to the invention, the additive can also include lignite particles which are also treated with surfactant and SBR, such that in one embodiment the additive comprises a mixture of particles of petroleum coke and lignite, which are impregnated with the surfactant and coated with SBR polymer.

The details of one or more embodiments of the invention are set forth in the description below. Other features, objects, and advantages of the invention will be apparent from the description, drawings and claims.

### BRIEF DESCRIPTION OF THE DRAWINGS

A detailed description of preferred embodiments of the invention follows, with reference to the attached drawings, wherein:

FIGS. 1-3 show results of filtration control testing with the present invention as compared to conventional additives.

### DETAILED DESCRIPTION

Drilling fluids are typically used in conjunction with drilling wellbores for use in extracting fluids from subterranean formations. One important property of the drilling fluid is the ability to form a filter cake which can sufficiently resist filtration, which is the invasion of well fluids through the wall of the wellbore and into the surrounding formation. During drilling, overpressure of fluids in the well cause the drilling fluid to form this filter cake on the wall of the wellbore and the cake resists flow of wellbore fluids into the formation.

While various methods exist for creating the filter cake, a common drawback is a lack of sufficient strength, elasticity and high costs. Many known additives for forming a filter cake are based upon organophilic lignite, copolymer of acrylamide and organophilic tannin, which control the volume of filtrate. However, some or all of these ingredients are expensive and may have limited availability. The present invention provides an additive which produces desirable rheology, permeability and strength in an affordable way. The present invention provides an additive based on petroleum coke composites and these composites affect the permeability of the filter cake, as an intermediate blocker of pores. A solid composition of petroleum coke provides good filter control without affecting rheology.

According to present invention, a filtration control additive can be made using a particulate petroleum coke, a butadiene-styrene polymer, a cationic surfactant, a fatty acid, isopropyl alcohol, and cyclohexane. The petroleum coke can preferably be Petrocedeño coke, which is desirable because it is available in sufficient quantities and at a low cost, and it has been found to be surprisingly effective when incorporated into a filtration loss additive according to the invention. Petrocedeño coke is much more readily available than other ingredients and is typically produced from basic oil refining methods and processes. Table 1 below presents examples of petroleum cokes which are suitable for use in accordance with the present invention, including Petrocedeño petroleum coke as described above.

TABLE 1
Physical and chemical analyses of cokes
(Eastern Cryogenic Complex)

| Coke | C | H | S | V | Ni | Ratio | Na | Humidity | Ash |
|---|---|---|---|---|---|---|---|---|---|
| (ACCRO) | (%) | (%) | (%) | (ppm) | (ppm) | V/Ni | (ppm) | (%) | (%) |
| Petrocedeño | 81.85 | 3.59 | 4.62 | 2,465 | 480 | 5.1 | 304 | 5.42 | 0.538 |
| Petroanzoátegui | 84.77 | 5.07 | 4.50 | 2,101 | 419 | 5.0 | 443 | 0.56 | 0.506 |
| Petromonagas | 84.87 | 4.79 | 4.56 | 3,200 | 619 | 5.2 | 485 | 1.47 | 0.514 |
| Petropiar | 84.81 | 4.90 | 4.47 | 2,160 | 460 | 4.7 | 469 | 3.45 | 0.574 |

As set forth above, a suitable petroleum coke can have a carbon content of between about 81 and 85% wt, a hydrogen content of between about 3 and 6% wt, a sulfur content of between about 4 and 5% wt, a vanadium content of between about 2,000 and 3,500 ppm, a nickel content of between about 400 and 650 ppm, a ratio of vanadium to nickel of between about 4.5 and 5.5, a sodium content of between about 300 and 500 ppm, a humidity of between about 0.5 and 6.0% vol, and an ash content of between about 0.5 and 0.6% wt.

The filtration control additive of the present invention can be made by mixing a cationic surfactant with petroleum coke particles of the indicated size at a set temperature, preferably at least about 50° C., more preferably between about 50° C. and 75° C., so as to absorb and impregnate the particles with the surfactant. The impregnated coke particles can then be coated with a butadiene-styrene polymer, such as SBR-8113. The coating is preferably done by adding the impregnated particles to a mixture comprising butadiene-styrene polymer dispersion in cyclohexane, for example a 7% organic dispersion of SBR in cyclohexane, and stirring so as to coat the particles with butadiene-styrene polymer. Mixing the SBR-8113 co-polymer is best done at a temperature of at least about 50° C., and in any event at a temperature in the range of between about 50° C. and 75° C.

When mixing, the petroleum coke particles should be used in an amount sufficient to provide the final additive with a content of petroleum coke between about 48% and 86% by weight with respect to the additive, with 10-30 of weight of lignite particles if desired. The balance of weight of the particles is absorbed surfactant and polymer coating.

As set forth above the additive can also contain lignite particles. Lignite is a typical additive in filtration control products and mechanisms, and a combination of petroleum coke and lignite particles has been found to be useful as a filtration control additive according to the invention.

The cationic surfactant used according to the invention is preferably a surfactant that will readily absorb or impregnate into the petroleum coke (also referred to herein as petcoke) particles, and produce good properties of filtration control. The cationic surfactant can preferably be based on a fatty acid, for example having a typical alkyl distribution of (C₁₂ 1%, C₁₄ 14%, C₁₆ 31% and C₁₈ 64%).

The additive according to the invention can be incorporated into a drilling fluid, and is particularly well suited for use in an oil-based drilling fluid. A typical drilling fluid including an additive according to the invention (referred to herein as FCC) as well as a fluid having a known additive (referred to herein as FLO) can have compositions as follows:

TABLE 2
Based formulation of oil-based drilling fluid

| Formulation | un | FLO | FCC |
|---|---|---|---|
| Mineral oil | ml | 220 | 220 |
| Organophilic clay | lb | 8 | 8 |
| Polar actived | lb | 4 | 4 |
| Organophilic | lb | 14 | — |
| Petcoke composite | lb | — | 21 |
| Humectante | lb | 8 | 8 |
| Calcium hydroxide | lb | 1.5 | 1.5 |
| Barite (D_{L} = 12 | lb | 283 | 283 |

The additive of the present invention was tested and found suitable at 300° F./500 psi, conditions that qualify the additive as an HPHT (high pressure high temperature) additive. Under search conditions, the additive shows properties that are as good as or better than those obtained using conventional or known additives. The additive of the present invention can be prepared using ingredients which are much more readily available, and produces surprisingly favorable results.

The method of the invention can be used in drilling new formations or can be retrofitted to wellbores that will be further extended. Aspects of the method can be applied to wellbores on an as needed basis.

A number of different additives were prepared and tested to evaluate the additive of the present invention. Impregnation and controlled adsorption of cationic surfactant were conducted on petroleum coke particles, mixed lignite and petroleum coke particles, and mixed petroleum coke and imported lignite particles at a temperature of 65.5° C. Subsequently, an SBR-8113 co-polymer dispersion in cyclohexane was added with continuous stirring to provide coated and impregnated coke particles. Table 3 below shows the different petcoke composites prepared on the basis of a 30 g sample for evaluation as filtration control additive.

Next, the effectiveness of composite petroleum coke additive according to the invention was tested against imported leanoardite type organophilic lignite. The test was conducted under conditions of 300° F. and 500 psi. The additive was mixed into a drilling fluid having the properties shown above in Table 2.

In filter cake testing for permeability, filter cakes based on conventional organophilic lignite had absolute permeability (k) of between 4.64-5.25 mD. By contrast filter cakes based on the additive of the present invention had absolute permeability of between 3.60-3.97 (Table 4).

TABLE 4
Permeability (k) of filtration cakes for RMN-H¹

| | Length | Diameter | Radius | Permeability (K) |
|---|---|---|---|---|
| Composite | (mm) | (mm) | (mm) | (mD) |
| FLO | 1.55 | 55.19 | 27.595 | 4.64-5.25 |
| FCC | 1.74 | 54.41 | 27.205 | 3.60-3.91 |
| FCC/30LI | 1.60 | 54.41 | 27.205 | 3.97 |
| FCC/30LN | 1.61 | 54.45 | 27.225 | 3.90 |

In terms of filtration control, each sample tested was evaluated for fluid loss over a standardized test. Additive using petroleum coke particles according to the invention exerted filtration control similar to imported organophilic lignite. However, the composites of petroleum coke particles and domestic or imported lignite gave the best filtration control values.

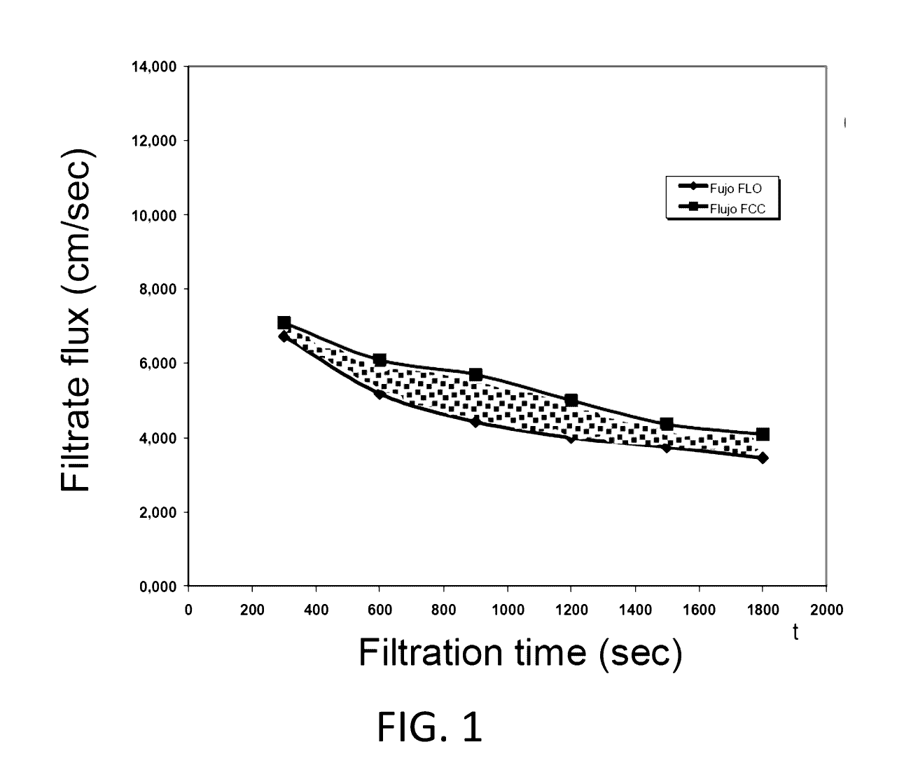

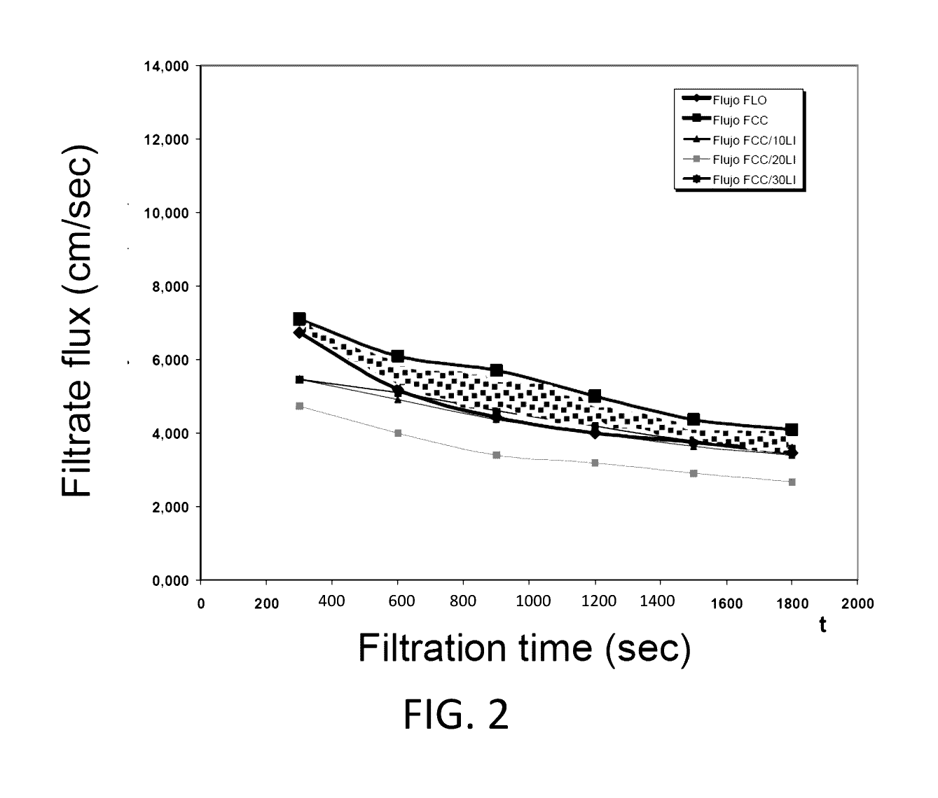

Results are shown in FIGS. 1-3. FIG. 1 shows filtration loss control of the additive according to the invention (FCC) as compared to an additive made with organophilic lignite (FLO). As shown, performance of the inventive FCC additive is nearly as good as the expensive lignite based additive (FLO). FIG. 2 shows results similar to FIG. 1, but also shows results obtained using combined petroleum coke particle and lignite additive (FCC/LI) with the amount of lignite additive being 10, 20 and 30% wt. (FCC/10LI, FCC/20LI and FCC/30LI). As shown, results for all of the combined additives (FCC/LI) were comparable or better than the organophilic lignite (FLO) additive. The best results were obtained with the additive containing 20% wt of the lignite particles mixed with petroleum coke particles according to the invention.

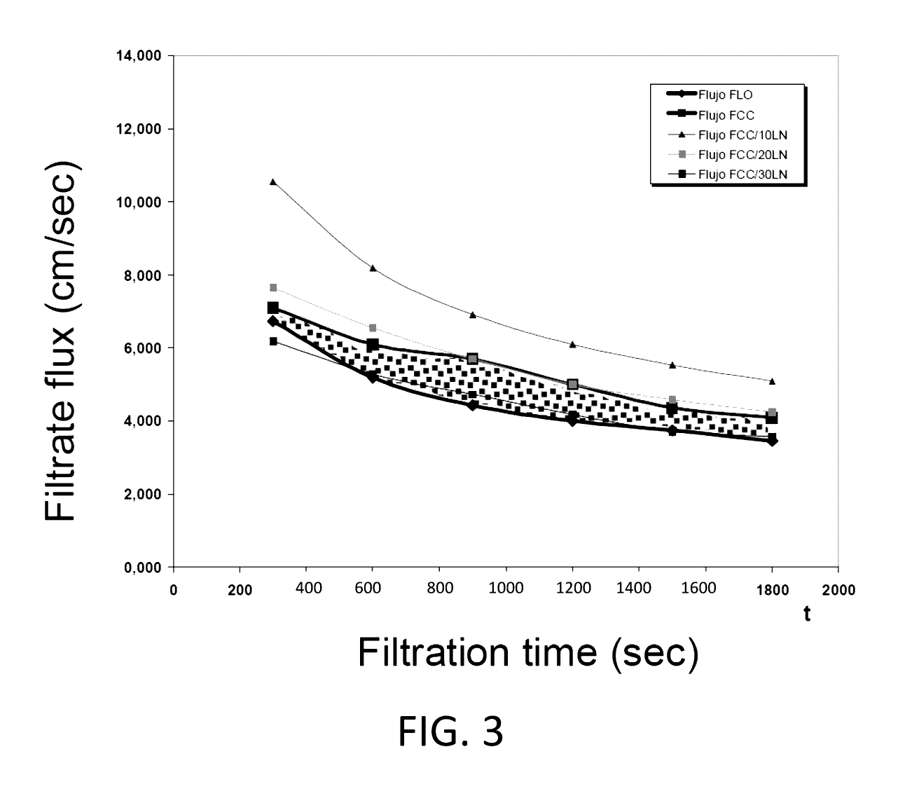

FIG. 3 shows testing results similar to FIG. 2, but in this case showing results obtained with an additive containing different amounts of domestic lignite particles mixed with the petroleum coke particles (FCC/10LN, FCC/20LN and FCC/30LN). The results here were also comparable to those obtained using the FLO additive. In this case, the best results were obtained using 30% wt of the domestic lignite particles mixed with petroleum coke particles according to the invention.

The testing showed that organophilic lignite showed an average filtrate of 5.7±0.1 ml. The filtering control mechanism is believed to be through the formation of a filtration cake, which is consistent with the literature. The composite of petroleum coke particles (FCC) provided an average filtrate volume of 6.8±0.1 ml, 1.1 ml higher than the filtrate shown by the organophilic lignite. The blocking mechanism for the inventive additive was found to be pore constriction and fully blocked. The composite of petroleum coke particles and imported natural lignite showed an average filtrate volume of 5.3±0.1 ml, somewhat lower (0.4 ml) than that achieved with the organophilic lignite. Like the above, it is believed that the trend is toward a locking mechanism pore constriction and complete blocking. The composite of petroleum coke particles and domestic natural lignite also dispersed properly, and the average filtrate volume was 7.1±0.1 ml, 1.4 ml greater than the conventional organophilic lignite. The blocking mechanism are found, formation of filtration cake and intermediate blocking. The permeability of the filter cake composites formed by petroleum coke particles (FCC) and petcoke-lignites (domestic and imported) are lower compared to the permeability given by the filter cake with organophilic lignite (FLO). This decrease of the permeability of the filter cake, between 19.8% and 24.0% is with the application of the petroleum coke particle composites according to the invention.

The present invention provides a novel and non-obvious filtration control additive, as well as methods for making and using same. One or more embodiments of the present invention have been described. Nevertheless, these embodiments are not to be viewed as limiting on the scope of the invention, which can be modified without departing from the spirit and scope of the invention. Accordingly, the scope of the invention is defined by the following claims.

What is claimed is:

1. A method for controlling filtration losses during drilling to a downhole hydrocarbon bearing formation, comprising drilling a well bore with a drilling fluid containing a filtration control additive so as to form a filter cake on a wall of the well, wherein the filtration control additive comprises petroleum coke particles having a particle size between 190 and 200 mesh, said particles being impregnated with a cationic surfactant and coated with a butadiene-styrene polymer.

2. The method of claim 1, wherein the petroleum coke particles are particles of Petrocedeño coke.

3. The method of claim 1, wherein the butadiene-styrene polymer is SBR-8113.

4. The method of claim 1, wherein the cationic surfactant is hydrogenated tallow amine.

5. The method of claim 1, wherein the additive further comprises lignite particles.

6. The method of claim 1, wherein the additive is a solid.

7. The method of claim 1 wherein the additive has an average particle size of about 200 mesh.

8. The method of claim 1, wherein the petroleum coke particles are between 48% and 86% by weight of the additive.

9. The method of claim 1, wherein the filter cake exhibits an absolute permeability of between 3.50 and 3.97 mD.

10. The method of claim 1, wherein the drilling fluid is an oil-based drilling fluid.

11. A method for making a filtration control additive for controlling filtration losses during drilling to a downhole hydrocarbon formation, comprising the steps of:
(a) mixing a cationic surfactant with petroleum coke particles so as to absorb and impregnate the particles with the surfactant to produce surfactant-impregnated particles;
(b) forming a mixture of the surfactant-impregnated particles and a butadiene-styrene polymer dispersion in cyclohexane, and
(c) mixing the mixture so as to coat the surfactant-impregnated particles with butadiene-styrene polymer.

12. The method of claim 11, wherein step (c) is carried out at a mixing intensity of about 90 rpm for about 6 hours.

13. The method of claim 11, wherein step (a) is carried out at a temperature of at least about 50° C.

14. The method of claim 11, wherein the petroleum coke particles are particles of Petrocedeño coke.

15. The method of claim 11, wherein the butadiene-styrene polymer is SBR-8113.

16. The method of claim 11, wherein the additive contains the petroleum coke particles in an amount between 48% and 86% by weight of the additive.

17. The method of claim 11, wherein step (c) produces the filtration control additive in solid form.

18. A drilling fluid filtration control additive, comprising petroleum coke particles having a particle size between 190 and 200 mesh, said particles being impregnated with a cationic surfactant and coated with a butadiene-styrene polymer.

19. The additive of claim 18, wherein the particle size of the additive is about 200 mesh.

20. The additive of claim 18, wherein the petroleum coke is Petrocedeño coke.

21. The additive of claim 18, wherein the butadiene-styrene polymer is SBR-8113.

22. The additive of claim 18, wherein the cationic surfactant is hydrogenated tallow amine.

23. The additive of claim 18, wherein the additive further comprises lignite particles.

24. The additive of claim 18, wherein the additive is a solid.

25. The additive of claim 18, wherein the additive contains the petroleum coke particles in an amount between 48% and 86% by weight of the additive.
